(19) United States
(12) Patent Application Publication
(10) Pub. No.: US 2007/0076428 A1
(43) Pub. Date: Apr. 5, 2007

(54) Festoon lamp

(76) Inventor: Chia-Yeh Wu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/239,043

(22) Filed: Sep. 30, 2005

(51) Int. Cl. F21S 4/00

(52) U.S. Cl. 362/565; 362/658; 362/240; 362/806

(57) ABSTRACT

The present invention discloses a festoon lamp, which comprises: a light-permeable tube, with two electrode contacts respectively installed at two ends of the light-permeable tube; a light-conducting element, installed inside the light-permeable tube; and two light sources, respectively installed at two ends of the light-conducting element, and respectively coupled to the two electrode contacts. The present invention can use minimum light sources to obtain a large light-emitting area, and thereby, the power consumption can be reduced obviously.

### BACKGROUND OF THE INVENTION

1. Field of the Invention

The present invention relates to an illuminator, particularly to a festoon lamp with a large light-emitting area and of low power consumption.

2. Description of the Related Art

Electronic products have been extensively used in various fields nowadays, and the vehicle industry also uses many electronic products unexceptionally, such as automobile headlights, automobile brake lights, motorcycle turn lights, etc. The lights used in vehicles must have the characteristics of rapid response, long service life, and high brightness lest traffic accidents occur owing to the poor visibility thereof.

In a vehicle lighting device, a light source is installed inside a lampshell, and the lampshell is then installed in a predetermined position. In tradition, such a light source is usually a tungsten filament bulb. Owing to the advances of science and technology, LED (Light Emitting Diode) has gradually replaced the traditional tungsten filament bulb. In comparison with the traditional tungsten filament bulb, LED has many advantages, such as small size, less heat generated, rapid response, and long service life. Nevertheless, LED is a point light source; thus, multiple LED's are assembled together to enhance the brightness and increase the illuminated area. Such a light source lacks shape diversification. Further, the light source of multiple LED's consumes much power.

Accordingly, the present invention proposes a festoon lamp to solve the abovementioned problems.

### SUMMARY OF THE INVENTION

The primary objective of the present invention is to provide a festoon lamp, wherein in contrast to that light is emitted by multiple LED's in the conventional technology, light is conducted by and emitted from a light-conducting element in the present invention, and thereby, the power consumption is reduced obviously.

Another objective of the present invention is to provide a festoon lamp, wherein light is conducted by and emitted from a light-conducting element, and a large light-emitting area can be obtained with minimum LED's.

The festoon lamp of the present invention comprises: a light-permeable tube, with two electrode contacts respectively installed at two ends of the light-permeable tube; a light-conducting element, installed inside the light-permeable tube; and at least one light source, installed at the end of the light-conducting element, and coupled to two electrode contacts.

To enable the objectives, technical contents, characteristics, and accomplishments of the present invention to be more easily understood, the embodiments of the present invention are to be described below in detail in cooperation with the attached drawings.

### BRIEF DESCRIPTION OF THE DRAWINGS

FIG. 1 is a section view according to the present invention.

FIG. 2 is an exploded section view according to one embodiment of the present invention.

FIG. 3 is an exploded section view according to another embodiment of the present invention.( Festoon Fuse Lamp)

### DETAILED DESCRIPTION OF THE INVENTION

The festoon lamp of the present invention is to be used as the lighting equipment of an automobile, such as turn lights, rear brake lights, third brake lights, etc. The festoon lamp of the present invention can provides a large light-emitting area by using only one light source; thus, the number of the light sources can be effectively reduced. The structure of the festoon lamp of the present invention is to be described below in detail.

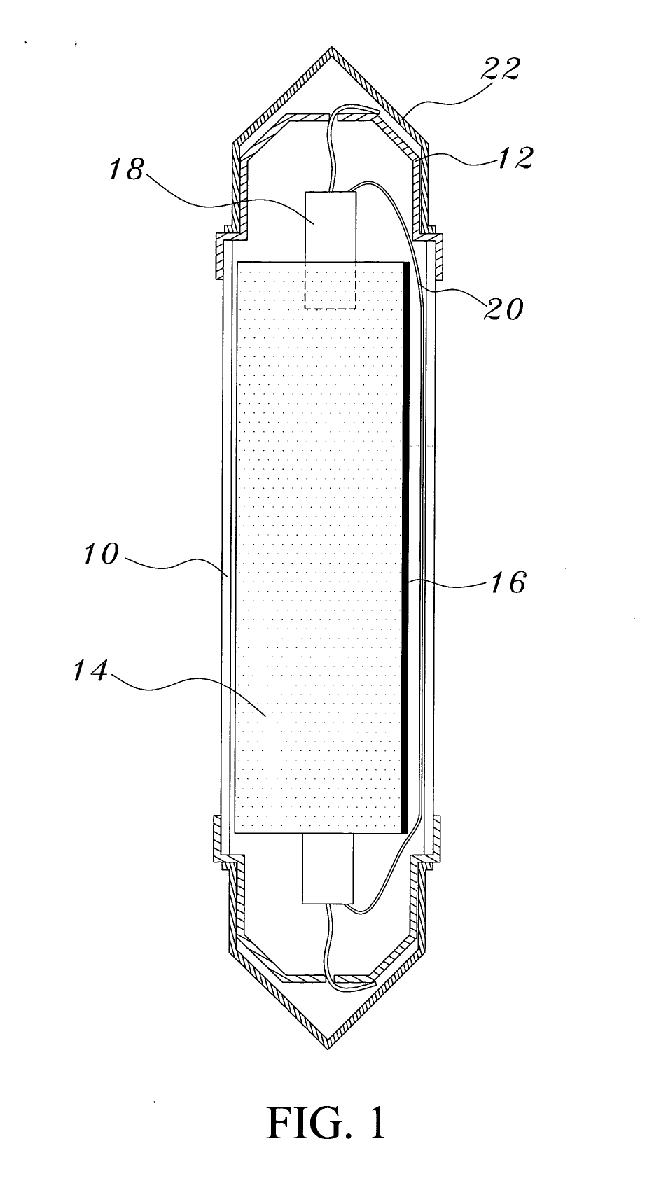

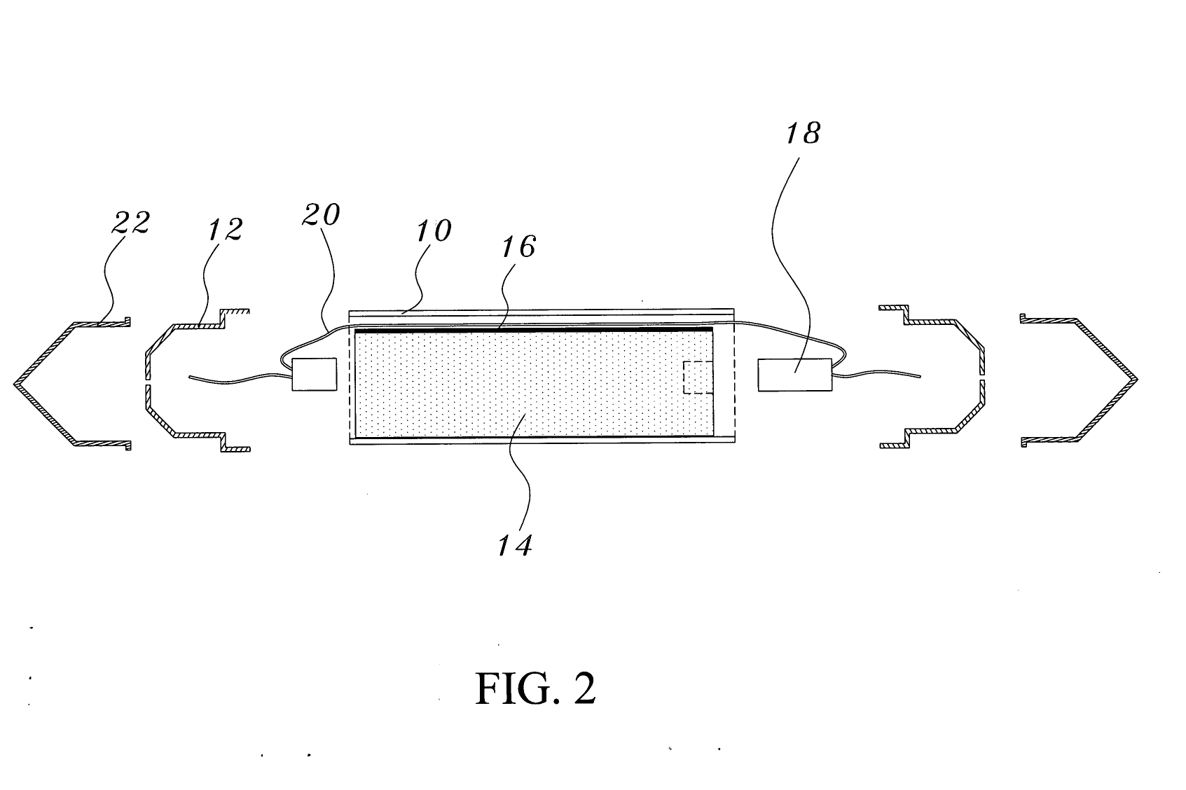

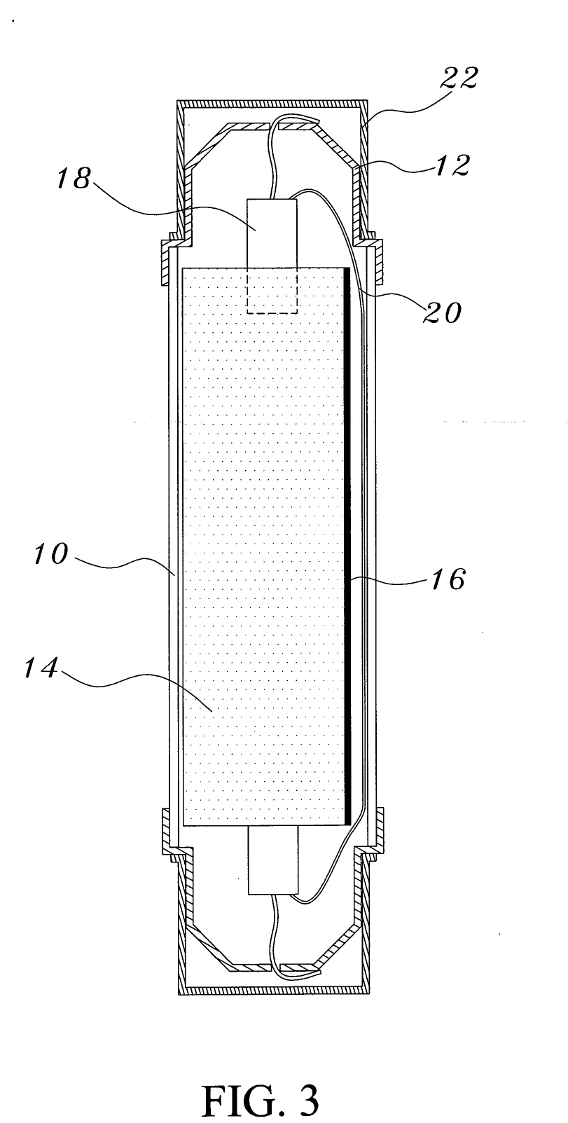

Refer to FIG. 1 and FIG. 2. The festoon lamp of the present invention comprises: a light-permeable tube 10, with two electrode contacts respectively installed at two ends of the light-permeable tube 10, wherein in this embodiment, the electrode contacts are two cable-clipping sleeves 12 separately fixedly holding two end of the light-permeable tube 10 for connecting with the power; a light-conducting element 14, installed inside the light-permeable tube 10, with a reflective film 16 installed on one side of the a light-conducting element 14; and a light source 18, installed at one end of the light-conducting element 14, wherein the light source 18 may be inlayed into or stuck onto the light-conducting element 14. In this embodiment, the light source 18 is inlayed into the light-conducting element 14, and cables 20 are used to connect the light source 18 to the cable-clipping sleeves 12, and the cable-clipping sleeves 12 will clip the cables 20. The cable 20 is disposed between the reflective film 16 and the light-permeable tube 10 and concealed by the reflective film 16. The light source 16 may be a LED or a tungsten filament bulb. Two metallic protection covers 22 respectively hood two cable-clipping sleeves 12 in order to protect the cable-clipping sleeves 12 and the cables 20. The end of the metallic protection cover 22 may be pointed or flattened, as shown in FIG. 3.

When the light source 18 at one end of the light-conducting element 14 is switched on to emit light, the light will be conducted by the light-conducting element 14 and reflected by the reflective film 16 so that the festoon lamp of the present invention will emit light. Besides, the light sources 18 can also be installed to both ends of the light-conducting element 14 in order to increase the brightness of the festoon lamp. Further, the festoon lamps of the present invention can be arranged into figures or characters to provide decoration effect in its application, and the color of the light source 18 can also be varied for usage diversification.

In summary, the present proposes a festoon lamp, wherein in contrast to that light is emitted by multiple LED's in the conventional technology, light is conducted by and emitted from a light-conducting element in the present invention. Thereby, the power consumption can be reduced obviously, and a large light-emitting area can be obtained with minimum LED's. Further, the festoon lamps of the present invention can be arranged into figures or characters to provide decoration effect in its application, and the color of the light source can also be varied for usage diversification.

The preferred embodiments of the present invention described above are to clarify the present invention to enable the persons skilled in the art to understand, make and use the present invention. However, those are not intended to limit the scope of the present invention. Any equivalent modification and variation according to the structures, shapes, characteristics or spirit stated in the claims of the present invention is to be included within the scope of the present invention.

What is claimed is:

1. A festoon lamp, comprising:
a light-permeable tube, with two electrode contacts respectively installed at two ends of said light-permeable tube for connecting with power;
a light-conducting element, installed inside said light-permeable tube; and
at least one light source, installed at the end of said light-conducting element, and coupled to said two electrode contacts.

2. The festoon lamp according to claim 1, wherein electrically-conductive cables are used to connect said light source to said two electrode contacts.

3. The festoon lamp according to claim 1, wherein two metallic protection covers are respectively installed to said two electrode contacts.

4. The festoon lamp according to claim 1, wherein said light source is inlayed into said light-conducting element.

5. The festoon lamp according to claim 1, wherein said light source is stuck onto said light-conducting element.

6. The festoon lamp according to claim 1, wherein said light source is a light emitting diode or a tungsten filament bulb.

7. The festoon lamp according to claim 1, wherein a reflective film is further installed on one side of said light-conducting element, and when light is emitted from said light source, said reflective film reflects the light conducted to said reflective film by said light-conducting element.

8. The festoon lamp according to claim 2, wherein a reflective film is further installed on one side of said light-conducting element, and said electrically-conductive cable is disposed between said reflective film and said light-permeable tube, and said reflective film conceals said electrically-conductive cable.

9. The festoon lamp according to claim 2, wherein two cable-clipping sleeves are respectively installed to two ends of said light-permeable tube in order to clip said electrically-conductive cables and function as said electrode contacts.
